(19) United States
(12) Patent Application Publication
(10) Pub. No.: US 2007/0262842 A1
(43) Pub. Date: Nov. 15, 2007

(54) Transformer having a closed magnetic flux path

(76) Inventors: Chun-Kong Chan, Hsi Chih City (TW); Chi-Ming Yang, Hsin Chuang (TW); Jin-Jiun Jiang, Hsin Chuang (TW); Ya-Chun Lai, Hsin Chuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/433,420

(22) Filed: May 15, 2006

(51) Int. Cl. H01F 27/28

(52) U.S. Cl. 336/170

(57) ABSTRACT

A transformer having a closed magnetic flux path includes at least one bobbin, at least one first winding, at least one second winding, and at least two magnetic cores. The first winding and the second winding are individually wound on the bobbin. The two magnetic cores include an I-shaped magnetic core and an E-shaped magnetic core piercing the inner part of the bobbin to form a closed magnetic flux path in the transformer. When one of the first windings is damaged, the other first winding still operates normally and is unaffected.

### BACKGROUND OF THE INVENTION

1. Field of the Invention

The present invention relates to a transformer having a closed magnetic flux path. In particular, this invention relates to a transformer having a closed magnetic flux path that is used for driving a plurality of CCFLs.

2. Description of the Related Art

As the dimension of LCD devices (such as LCD monitors or LCD TVs) becomes larger, LCD devices need more CCLFs to make the light emitted from the LCD devices brighter and more uniform.

As shown in FIG. 1, when the transformer 1 of the prior art provides a plurality of outputted driving signals, two first windings 11 and two second windings 12 are symmetrically located at single magnetic flux path 13. Each of the first windings 11 has a set of pins 111, and each of the second windings 12 has another set of pins 121. Each of the two first windings 11 are connected with a driving unit (not shown in the figure) via the pins 111. Similarly, each of the two second windings 12 are connected with a CCFL (not shown in the figure) via the pins 121. Therefore, the transformer provides two sets of outputted signals. However, when one of the first windings 11 is damaged or becomes decayed, the magnetic flux induced by the magnetic flux path 13 becomes so small that it affects the outputted signal from the two second windings 12. Therefore, the power supplied to the CCFL is inadequate, and the brightness of the CCFL is affected.

### SUMMARY OF THE INVENTION

One particular aspect of the present invention is to provide a transformer having a closed magnetic flux path. The transformer is connected with a plurality of driving units and provides a plurality of outputted signals. Its magnetic flux paths are independent of each other. When one of the first windings is damaged, the outputted signal is unaffected.

The transformer having a closed magnetic flux path includes at least one bobbin, at least one first winding, at least one second winding, and at least two magnetic cores. The bobbin includes at least two first coil frames and at least one second coil frame. The first winding includes at least two first coils wound on the first coil frame of the bobbin. The second winding includes a plurality of second coils wound on the second coil frame of the bobbin. The two magnetic cores pierce the bobbin to form at least two independent closed magnetic flux paths. Therefore, even though the first coil of one of the closed magnetic flux paths is damaged, the magnetic flux on the other closed magnetic flux path is not changed so the output of the second coil is stable.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the magnetic flux path of the transformer of the prior art;

FIG. 2 is a schematic diagram of the first embodiment of the present invention;

FIG. 3 is a schematic diagram of the closed magnetic flux path of the present invention;

FIG. 4 is a schematic diagram of the closed magnetic flux path and two coils wound in parallel of the present invention;

FIG. 5 is a schematic diagram of the second embodiment of the present invention;

FIG. 6 is a schematic diagram of the third embodiment of the present invention;

FIG. 7 is a schematic diagram of the fourth embodiment of the present invention; and

FIG. 8 is a schematic diagram of the transformer having a plurality of driving ports and a plurality of output ports of the present invention.

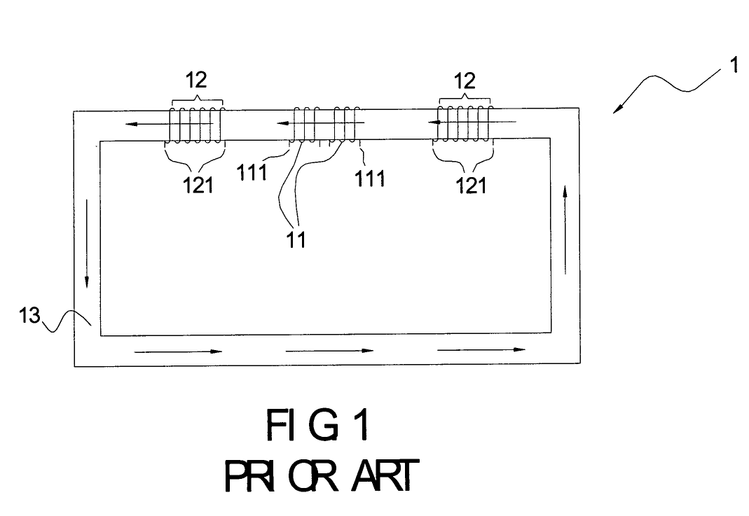

### DETAILED DESCRIPTION OF THE PREFERRED EMBODIMENTS

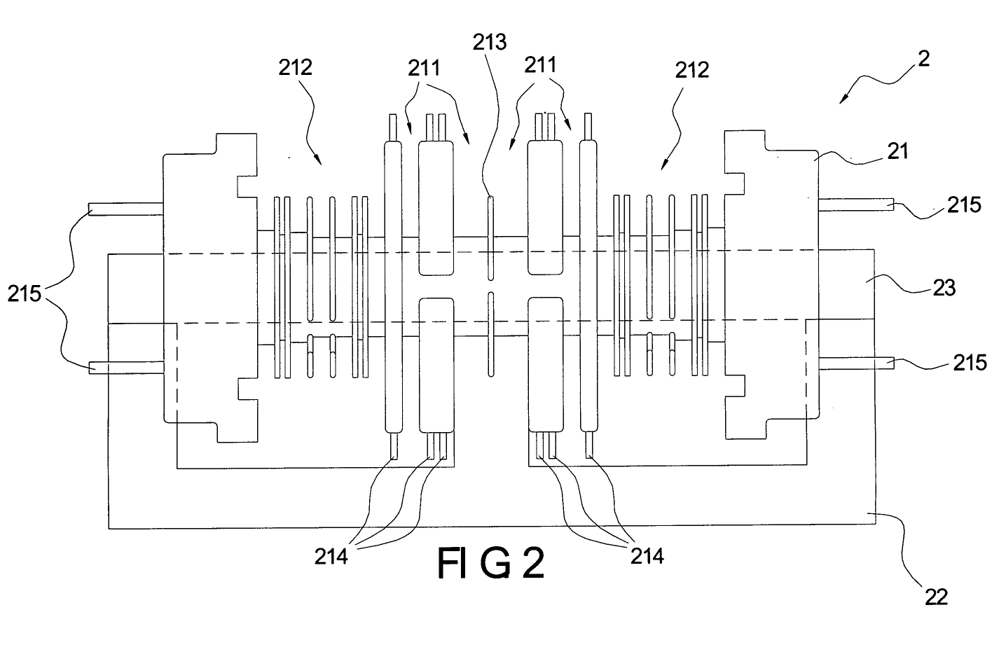

Reference is made to FIG. 2. The transformer having a closed magnetic flux path 2 includes a bobbin 21, an E-shaped magnetic core 22, and an I-shaped magnetic core 23. The I-shaped magnetic core 23 pierces the inner part of the bobbin 21. The E-shaped magnetic core 22 is jointed with the I-shaped magnetic core 23 for forming a magnetic flux path 24 having a square-B-shaped (as shown in FIG. 3). The bobbin 21 includes four first coil frames 211 and two second coil frames 212. A separating-board 213 is located at the center of the bobbin 21 so as to separate the first coil frame 211 from the second coil frame 212. The first coil frame 211 is located symmetrically with the second coil frame 212. Two adjacent first coil frames 211 are located near the separating-board 213. The second coil frames are individually installed at the two sides of the bobbin 21 and are adjacent to the first coil frames 211. There are a plurality of first pins 214 and second pins 215 at the bobbin 21. The first pins 214 are adjacent to the first coil frames 21land the second pins 215 are adjacent to the second coil frames 212. The first coil frames 211 are wound with a first winding 25 and the second coil frames 212 are wound with a second winding 26 (as shown in FIG. 3). The first pins 214 are connected with the driving units (not shown in the figure) and the second pins 215 are connected with the CCFLs (not shown in the figure).

Reference is made to FIG. 3. The bobbin 21 (as shown in FIG. 2) is wound with two first windings 25 and two second windings 26 so that the two sides of the magnetic flux path 24 have the first winding 25 and the second winding 26 disposed symmetrically. The first winding 25 includes two first coils 251 and a compensating coil 252. Thereby, the two windings 25 are individually connected with a royer driving unit (not shown in the figure) via the first pin 214 and the two second windings 25 are individually connected with a CCFL via the second pin 215. When power is inputted into the first winding 25 via the royer driving unit, the magnetic flux path 24 forms two closed magnetic flux paths due to the current flows through the first winding 25 so as to generate magnetic flow. The two second windings 26 react to the magnetic flow to generate a current for driving the CCFLs to light. The compensating coil 252 makes the current generated at the second winding 26 more stable. When one royer driving unit connected with one first winding 25 at one of the closed magnetic flux paths 241 is damaged, an other closed magnetic flux path 241 is neither damaged nor affected because the two closed magnetic flux paths 241 are independent. Therefore, the undamaged closed magnetic flux path 241 enables the CCFL to light stably.

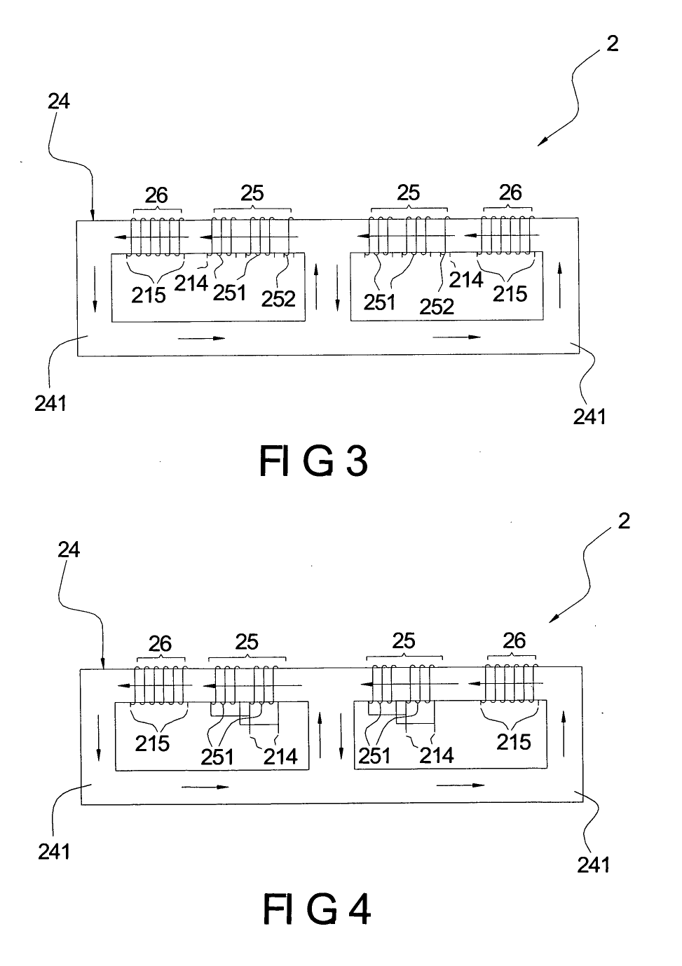

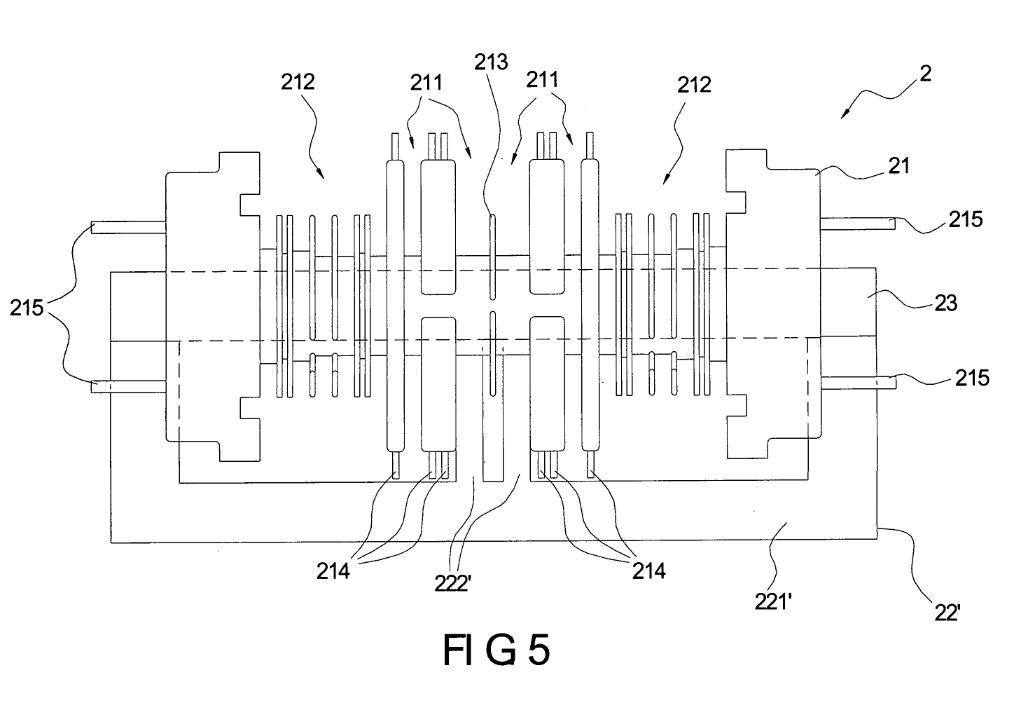

Reference is made to FIG. 4. The first winding 25 includes two first coils 251 and is connected with the driving unit (not shown in the figure) via the first pin 214 using a two wound wires method. The driving unit is a full-bridge, a half-bridge, or a push-pull type. The four first pins 214 of the first coils 251 are individually connected with the current output terminal MOSFET of the driving unit and another MOSFET. The two input pins 214 of the first coils 251 are electrically connected with the current input terminal MOSFET of the push-pull driving unit. The two output pins 214 of the first coils 251 are electrically connected with another MOSFET of the push-pull driving unit. By this method, the undamaged closed magnetic flux path 241 can operate normally and the two wound wires method lowers the collection effect of the first coil 251 and the temperature of the first coil 251 so as to protect the first winding 25.

Reference is made to FIG. 5. In this embodiment, the transformer having a closed magnetic flux path 2 includes a bobbin 21, a similar-E-shaped magnetic core 22′, and an I-shaped magnetic core 23. The similar-E-shaped magnetic core 22′ includes a U-shaped part 221′. Two parallel I-shaped parts 222′ extend upward from the center of the bottom of the U-shaped part 221′. The I-shaped magnetic core 23 pierces the inner part of the bobbin 21. The similar-E-shaped magnetic core 22′ is jointed with the I-shaped magnetic core 23 for forming a magnetic flux path 24 having a grating-shape. Thereby, two independent closed magnetic flux paths are achieved.

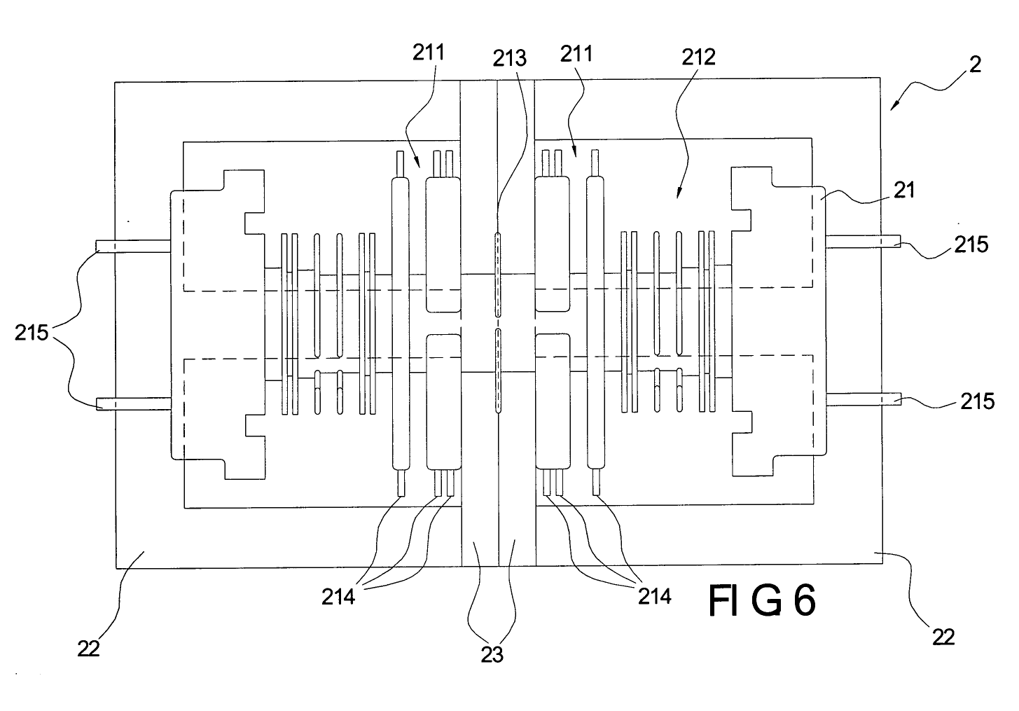

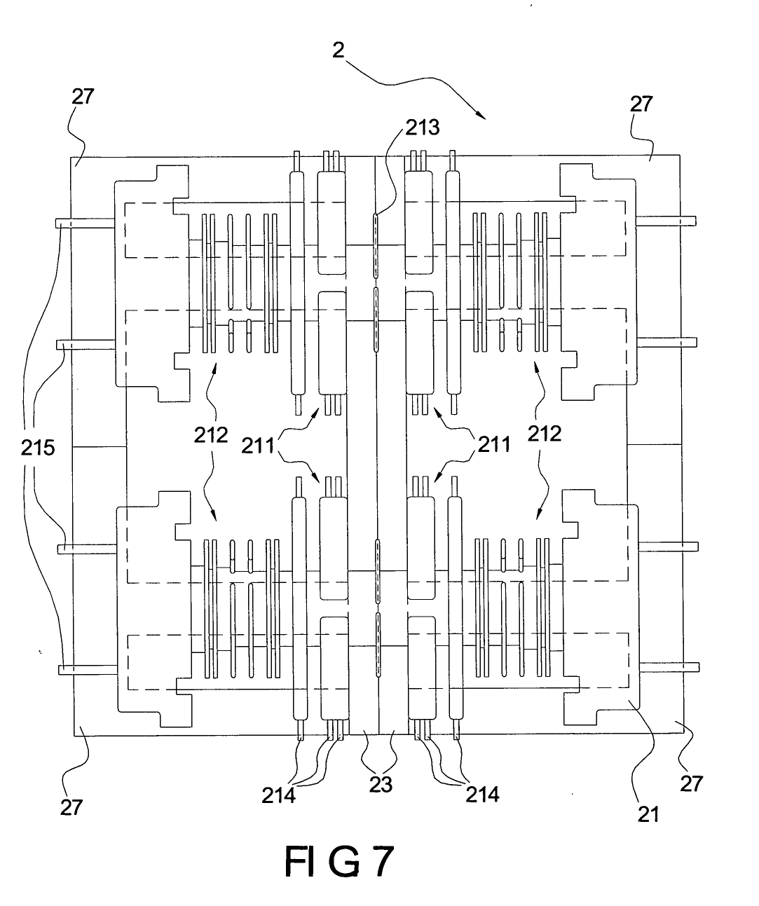

Reference is made to FIG. 6. In this embodiment, the transformer having a closed magnetic flux path 2 includes a bobbin 21, two E-shaped magnetic cores 22, and two I-shaped magnetic cores 23. The two I-shaped magnetic cores 23 are arranged in parallel at the center of the bobbin 21, are vertical to the bobbin 21 and straddle the bobbin 21. The center part of the two E-shaped magnetic cores 22 plugs into the bobbin 21 from the two ends of the bobbin 21. The two sides of the E-shaped magnetic cores 22 are individually jointed with the I-shaped magnetic core 23. Thereby, two independent closed magnetic flux paths are achieved.

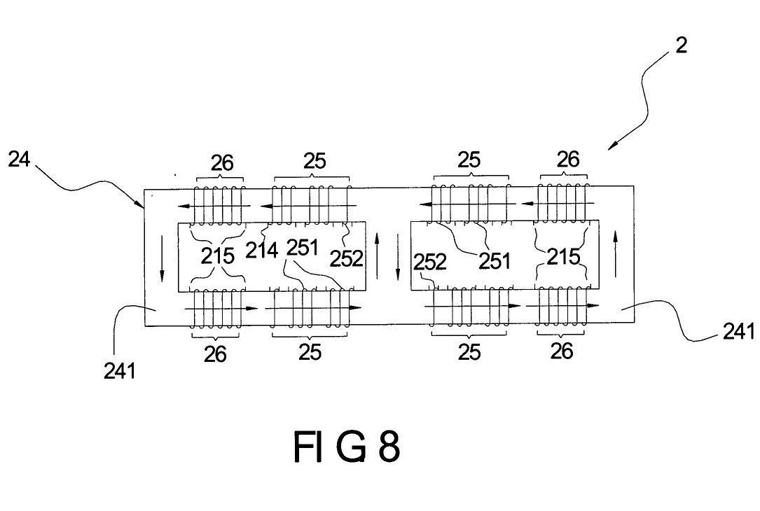

Reference is made to FIGS. 7 and 8. The transformer having a closed magnetic flux path 2 provides a plurality of outputs. In this embodiment, the transformer having a closed magnetic flux path 2 includes two bobbins 21, four F-shaped magnetic cores 27, and two I-shaped magnetic cores 23. The two bobbins 21 are the same as each other. The two I-shaped magnetic cores 23 are arranged in parallel at the center of the bobbin 21, and are vertical to the bobbin 21 and straddle the bobbin 21. The F-shaped magnetic cores 27 are individually plugged into the bobbins 21 and are adjacent to each other. The F-shaped magnetic cores 27 are individually jointed with the two I-shaped magnetic cores 23. The magnetic flux path 24 forms two independent closed magnetic flux paths 241, as shown in FIG. 8. Each of the closed magnetic flux paths 241 includes two first windings 25 and two second windings 26 so as to have multiple inputs and multiple outputs. Each of the closed magnetic flux paths 241 are independent from each other so that single closed magnetic flux paths 241 can output stably.

The transformer having a closed magnetic flux path prevents the problem of the output of all second windings being affected when the single first winding is damaged. The two wound wires method lowers the collection effect and temperature to protect the first winding. Furthermore, collocating a variety of magnetic cores achieves the effect of having multiple inputs and multiple outputs and forms a plurality of magnetic flux paths.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A transformer having a closed magnetic flux path, comprising:
at least one bobbin having at least two first coil frames and at least one second coil frame;
at least one first winding having at least two first coils, wherein the two first coils are individually wound on the two first coil frames;
at least one second winding having a plurality of second coils wound on the second coil frame; and
at least two magnetic cores piercing the inner part of the bobbin to form a closed magnetic flux path.

2. The transformer having a closed magnetic flux path as claimed in claim 1, wherein the bobbin has a plurality of first pins and second pins, and the first winding is connected with a driving unit via the first pins.

3. The transformer having a closed magnetic flux path as claimed in claim 2, wherein the first winding is connected with the driving unit by a two wound wires method.

4. The transformer having a closed magnetic flux path as claimed in claim 2, wherein the driving unit is a full-bridge driving unit, a half-bridge driving unit, a push-pull driving unit, or a royer driving unit.

5. The transformer having a closed magnetic flux path as claimed in claim 1, wherein the magnetic cores includes at least one I-shaped magnetic core and at least one E-shaped magnetic core, and the I-shaped magnetic core is jointed with the E-shaped magnetic core.

6. The transformer having a closed magnetic flux path as claimed in claim 1, wherein the magnetic cores include a similar-E-shaped magnetic core and an I-shaped magnetic core, and the I-shaped magnetic core is jointed with the E-shaped magnetic core.

7. The transformer having a closed magnetic flux path as claimed in claim 1, wherein the magnetic cores include four F-shaped magnetic cores and two I-shaped magnetic cores, and the I-shaped magnetic cores are jointed with the F-shaped magnetic cores.
